(19) United States
(12) Patent Application Publication
(10) Pub. No.: US 2026/0299995 A1
(43) Pub. Date: Oct. 1, 2026

(54) MANAGING SYSTEM MANAGEMENT INTERRUPT (SMI) REQUESTS AT AN INFORMATION HANDLING SYSTEM

(71) Applicant: Dell Products L.P., Round Rock, TX (US)

(72) Inventors: Ibrahim Sayyed, Georgetown, TX (US); Laxmi Lavanya Medicherla, Georgetown, TX (US); Amit Kumar Tiwari, Austin, TX (US); Alan Helmy Abdelhalim, Pflugerville, TX (US)

(21) Appl. No.: 19/089,251

(22) Filed: Mar. 25, 2025

(51) Int. Cl. G06F 9/48

(52) U.S. Cl. CPC G06F 9/4831

(57) ABSTRACT

Managing system management interrupt (SMI) requests at an information handling system, including identifying, while the information handling system is performing in an OS mode, a plurality of SMI requests from the OS to firmware of the information handling system for telemetry data; monitoring the SMI requests including receiving computing parameter values related to the SMI requests; determining, based on the received computing parameter values, a SMI workload of the information handling system; comparing the SMI workload to a threshold; determining, based on the comparing, that the SMI workload is greater than the threshold, and in response: determining whether a user of the information handling system is present with respect to the information handling system; determining that the user of the information handling system is present with respect to the information handling system, and in response: throttling a frequency of the SMI requests between the OS and the firmware.

### BACKGROUND

### Field of the Disclosure

The disclosure relates generally to an information handling system, and in particular, managing system management interrupt (SMI) requests at the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

System Management Interrupt (SMI) is a special type of interrupt used by computer systems to handle critical events that require immediate attention from the system firmware. It plays a key role in managing tasks such as power management and system diagnostics. SMI is part of the System Management Mode (SMM), which is a special operating mode designed for handling system-wide functions like hardware control and power management. This mode is typically used by system firmware and is not accessible to general-purpose software.

### SUMMARY

Innovative aspects of the subject matter described in this specification may be embodied in a method of managing system management interrupt (SMI) requests at an information handling system, the method including identifying, while the information handling system is performing in an operating system (OS) mode, a plurality of SMI requests from the OS to firmware of the information handling system for telemetry data; monitoring the SMI requests including receiving computing parameter values related to the SMI requests; determining, based on the received computing parameter values, a SMI workload of the information handling system; comparing the SMI workload to a threshold; determining, based on the comparing, that the SMI workload is greater than the threshold, and in response: determining whether a user of the information handling system is present with respect to the information handling system; determining that the user of the information handling system is present with respect to the information handling system, and in response: throttling a frequency of the SMI requests between the OS and the firmware.

Other embodiments of these aspects include corresponding systems, apparatus, and computer programs, configured to perform the actions of the methods, encoded on computer storage devices.

These and other embodiments may each optionally include one or more of the following features. For instance, the computing parameter values include memory paging, processor workload, and SMI request frequency. Determining the SMI workload includes determining the SMI workload based on the memory paging, the processor workload, and the SMI request frequency. Determining that the user of the information handling system is not present with respect to the information handling system, and in response: maintaining the frequency of the SMI requests between the OS and the firmware. Determining, based on the comparing, that the SMI workload is greater than the threshold, and in response: determining whether a workload of the information handling system includes a media workload; determining that the workload of the information handling system includes the media workload, and in response: throttling a frequency of the SMI requests between the OS and the firmware. Determining, based on the comparing, that the SMI workload is greater than the threshold, and in response: determining whether a workload of the information handling system includes a media workload; determining that the workload of the information handling system does not include the media workload, and in response: maintaining the frequency of the SMI requests between the OS and the firmware. Determining, based on the comparing, that the SMI workload is less than the threshold, and in response: maintaining the frequency of the SMI requests between the OS and the firmware.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing system management interrupt (SMI) requests.

FIG. 3 illustrates a method for managing system management interrupt (SMI) requests.

### DESCRIPTION OF PARTICULAR EMBODIMENT(S)

This disclosure discusses methods and systems for managing system management interrupt (SMI) requests of an information handling system. In short, System Management Interrupt (SMI) on OS to Embedded Controller (EC) communication facilitates interactions between the operating system and the EC. This process involves triggering an SMI, which causes the system to switch from the OS context to the System Management Mode (SMM) to handle the communication with the EC. However, this method has performance implications. Each SMI request triggers a context switch from the OS to the EC, which can be costly in terms of performance. For instance, retrieving more data from the EC can require multiple SMI requests, leading to significant performance overhead.

Specifically, this disclosure discusses a system and a method for managing system management interrupt (SMI) requests at an information handling system, including identifying, while the information handling system is performing in an operating system (OS) mode, a plurality of SMI requests from the OS to firmware of the information handling system for telemetry data; monitoring the SMI requests including receiving computing parameter values related to the SMI requests; determining, based on the received computing parameter values, a SMI workload of the information handling system; comparing the SMI workload to a threshold; determining, based on the comparing, that the SMI workload is greater than the threshold, and in response: determining whether a user of the information handling system is present with respect to the information handling system; determining that the user of the information handling system is present with respect to the information handling system, and in response: throttling a frequency of the SMI requests between the OS and the firmware.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

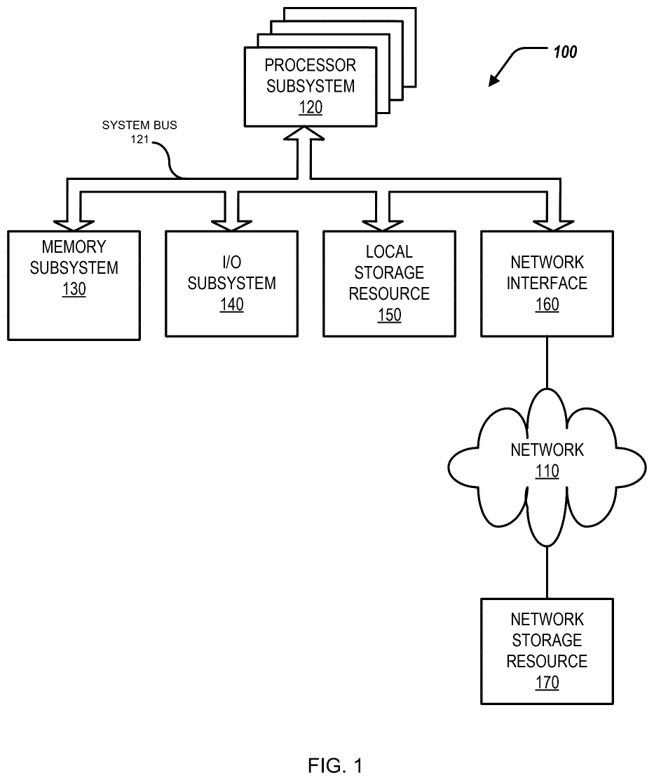

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

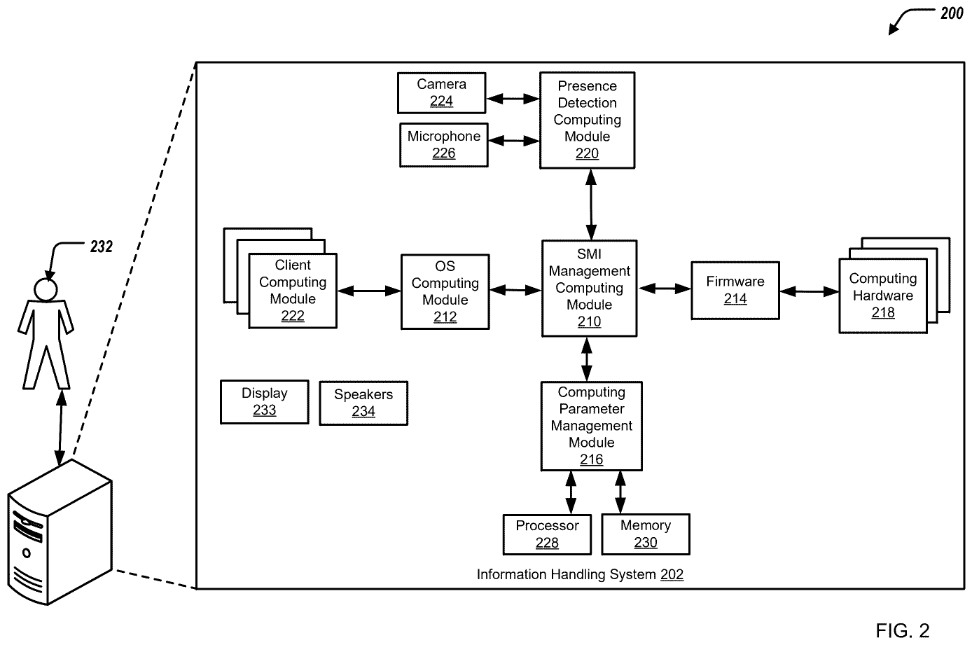

Turning to FIG. 2, FIG. 2 illustrates an environment 200 including an information handling system 202. The information handling system 202 can include a system management interrupt (SMI) management computing module 210, an OS computing module 212, firmware 214, a computing parameter management module 216, computing hardware 218, a presence detection computing module 220, client computing modules 222, a camera 224, a microphone 226, a processor 228, memory 230, a display 233, and speakers 234. In some examples, the information handling system 202 is similar to, or includes, the information handling system 100 of FIG. 1.

The SMI management computing module 210 can be in communication with the OS computing module 212, the firmware 214, and the computing parameter management module 216. The OS computing module 212 can be in communication with the SMI management computing module 210 and the client computing modules 222. The firmware 214 can be in communication with the SMI management computing module 210 and the computing hardware 218. The computing parameter management module 216 can be in communication with the SMI management computing module 210, the processor 228, and the memory 230. The computing hardware 218 can be in communication with the firmware 214. The presence detection computing module 220 can be in communication with the SMI management computing module 210, the camera 224, and the microphone 226. The client computing modules 222 can be in communication with the OS computing module 212.

In some examples, the OS computing module 212 can include the OS of the information handling system 202, or be a representation of the OS of the information handling system 202. In some examples, the OS computing module 212 can indicate values of metrics or parameters of the OS of the information handling system 202. In some examples, the OS computing module 212 is the OS of the information handling system 202. In some examples, the OS computing module 212 can be in communication with the OS of the information handling system 202.

The firmware 214 can provide low-level control of the computing hardware 218. In some examples, the firmware 214 can include the firmware of the information handling system 202, or be a representation of the firmware of the information handling system 202. In some examples, the firmware 214 can indicate values of metrics or parameters of the firmware of the information handling system 202. In some examples, the firmware 214 is the firmware of the information handling system 202. In some examples, the firmware 214 can be in communication with the firmware of the information handling system 202. In some examples, the firmware 214 can be an embedded controller (EC) or the basic input/output system (BIOS).

The computing hardware 218 can include memory, storage devices, video cards, audio cards, processors, and the like.

In some examples, the client computing module 222 can include a computer-implemented application (or computer-executable application, or computer software, or computer-executable software), or be a representation of the computer-implemented application.

In short, the System Management Interrupt (SMI) on OS to Embedded Controller (EC) communication facilitates interactions between the operating system and the EC. This process involves triggering an SMI, which causes the system to switch from the OS context to the System Management Mode (SMM) to handle the communication with the EC. However, this method has performance implications. Each SMI request triggers a context switch from the OS to the EC, which can be costly in terms of performance. For instance, retrieving more data from the EC can require multiple SMI requests, leading to significant performance overhead.

The present invention discusses detecting and monitoring real-time SMI usage from telemetry and diagnostic software workloads to meet the data needs for applications, providing commodity-level insights. Additionally, it monitors the SMI frequency in terms of Host-EC communication and polices the round-trip time. For example, the presence of media streams (audio/video) is monitored, and human presence detection sensor data is utilized to throttle the frequency of Host-EC communication to avoid issues such as audio jittering, audio lag, and video lag. Furthermore, the invention can detect SMI performance impact and perform adaptive behavior to reduce or avoid operations that cause such issues.

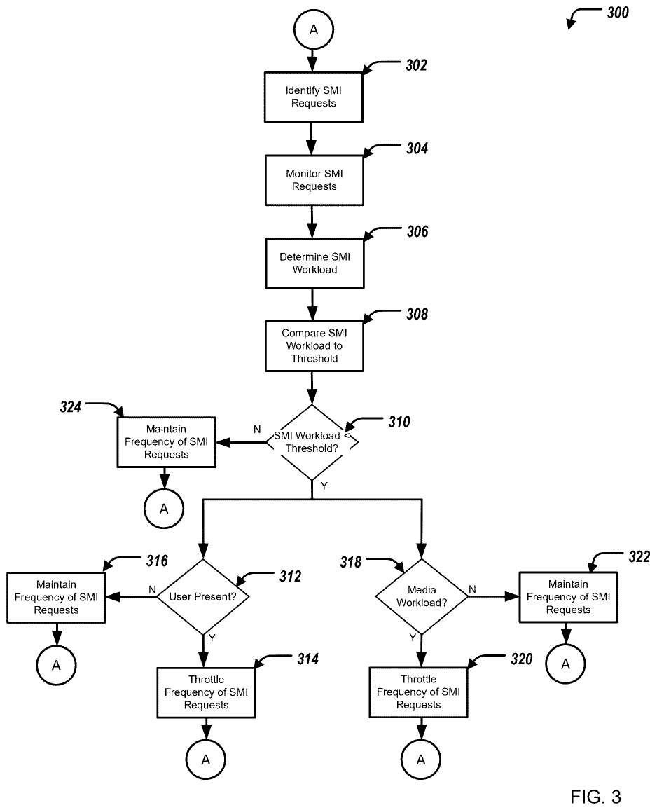

FIG. 3 illustrates a flowchart depicting selected elements of an embodiment of a method 300 for managing system management interrupt (SMI) requests. The method 300 may be performed by the information handling system 100, the information handling system 202, the SMI management computing module 210, the OS computing module 212, the firmware 214, the computing parameter management module 216, and/or the presence detection computing module 220, and with reference to FIGS. 1-2. It is noted that certain operations described in method 300 may be optional or may be rearranged in different embodiments.

The SMI management computing module 210 identifies SMI requests from the OS computing module 212 to the firmware 214 for telemetry data, at 302. Specifically, the OS computing module 212 can provide SMI requests to the firmware 214 through the SMI management computing module 210. The OS computing module 212 can generate the SMI requests directly, or receive the SMI requests from the client computing module 222 to contact the firmware 214 via the SMI management computing module 210.

The SMI requests can be received by the SMI management computing module 210 while the information handling system 202 is performing in an operating system (OS) mode. That is, the information handling system 202 is performing within the OS context.

The telemetry data can represent properties, parameters, and the like, of the computing hardware 218. For example, the telemetry data can include processor parameters, temperature of the computing hardware 218, processing parameters of the computing hardware 218, data access parameters of memory, battery information, battery state, network performance parameters and speed, BIOS version, OS version, and the like.

For example, the OS computing module 212 can provide a SMI request to collect fan speed telemetry data (during high-temperature conditions) every 0.5 seconds. That is, the client computing module 222 can generate a SMI request for the fan speed telemetry data of the fan (computing hardware 218) through the OS computing module 212 that sends the SMI request to the firmware 214 that collects the fan speed telemetry data from the fan (computing hardware 218).

For example, the OS computing module 212 can provide a SMI request to collect battery telemetry every 1 second. That is, the client computing module 222 can generate a SMI request for the battery telemetry data of the battery (computing hardware 218) through the OS computing module 212 that sends the SMI request to the firmware 214 that collects the battery telemetry data from the battery (computing hardware 218).

For example, the OS computing module 212 can provide a SMI request to collect battery management unit (BMU) telemetry data (such as full charge capacity (FCC), battery degradation/wear out) for battery analysis. That is, the client computing module 222 can generate a SMI request for the BMU telemetry data of the battery (computing hardware 218) through the OS computing module 212 that sends the SMI request to the firmware 214 that collects the BMU telemetry data from the battery (computing hardware 218).

The SMI management computing module 210 monitors the SMI requests, including receiving computing parameter values related to the SMI requests, at 304. Specifically, the computing parameter management module 216 can receive data indicating computing parameter values from the processor 228 and the memory 230. For example, the computing parameter management module 216 can receive data indicating the processor workload of the processor 228 and data indicating memory paging of the processor 228. The computing parameter management module 216 can receive such data periodically, and provide the same to the SMI management computing module 210. The SMI management computing module 210 can receive the data indicating the memory paging of the memory 230 from the computing parameter module 216 as an “High Paging Activity Alert.” The SMI management computing module 210 can receive the data indicating the processor workload of the processor 228 from the computing parameter management module 216 as a “CPU High Activity Alert.”

Furthermore, the computing parameter values can include a SMI request frequency by the OS computing module 212. That is, how often or how frequent the OS computing module 212 is performing an SMI request to the SMI management computing module 210 in a time period. For example, the SMI request frequency can be every 0.1 seconds, 1 second, 1 minute, etc. The SMI management computing module 210 can analyze the SMI request frequency and generate a “High SMI Activity Alert.” The SMI management computing module 210 can determine the SMI request frequency, as well as determine a length of time of each SMI request. That is, the amount of time the SMI request takes to obtain the data from the computing hardware 218 through the firmware 214 (“round trip time” or “overall routed time”). Thus, the computer parameter values can further include the SMI request frequency that can include how often the SMI requests are performed, and length of time to satisfy the SMI request.

The SMI management computing module 210 determines, based on the received computing parameter values, a SMI workload of the information handling system 202, at 306. In other words, the SMI management computing module 210 detects and monitors a SMI workload (SMI usage) from the computing parameter values (telemetry/diagnostic workloads). Specifically, the SMI management computing module 210 can determine the SMI workload of the information handling system 202 based on one or more of the computing parameter values of the memory paging, the processor workload, and the SMI request frequency. In some examples, the SMI workload can be represented by one of the computing parameter values, or a combination of one or more of the computing parameter values. In some examples, the SMI workload is the memory paging, the processor workload, or the SMI request frequency. In some examples, the SMI workload is a combination of the memory paging, the processor workload, or the SMI request frequency.

The SMI management computing module 210 compares the SMI workload to a threshold, at 308. That is, the SMI management compares the SMI workload based on the received computing parameter values to a threshold. The threshold can be based on a desired performance criteria of the information handling system 202. In some examples, the threshold can be based on a media presentation at the information handling system through the display 233 and/or the speakers 234. That is, the threshold can be based on acceptable audio jittering, audio lag, and/or video lag of the media contact presented through the display 233 and/or the speakers 234. In some examples, the acceptable audio jittering, audio, and/or video lag can be zero (as perceived by a user 232 of the information handling system 202) or nearly zero, or substantially zero. In some examples, the threshold is based on a processing output, a computational speed, a computations per minute, or the like of the information handling system 202.

In some examples, when the SMI workload is represented by one of the computing parameter values, the SMI management computing module 210 compares the computing parameter value to a respective threshold. For example, when the SMI workload is represented by the memory paging, the SMI management computing module 210 compares the memory paging value to a memory paging threshold. For example, when the SMI workload is represented by the processor workload, the SMI management computing module 210 compares the processor workload value to a processor workload threshold. For example, when the SMI workload is represented by the SMI request frequency, the SMI management computing module 210 compares the SMI request frequency value to a SMI request frequency threshold.

In some examples, when the SMI workload is represented by a combination of (multiple) computing parameter values, the SMI management computing module 210 compares one or more of the computer parameter values to a respective threshold. In some examples, when the SMI workload is represented by a combination of (multiple) computing parameter values, the SMI management computing module 210 compares each of the computer parameter values to a respective threshold.

The SMI management computing module 210 determines whether, based on the comparing, the SMI workload is greater than the threshold, at 310. In some examples, when the SMI workload is represented by one of the computing parameter values, the SMI management computing module 210 determines whether the computing parameter value is greater than the respective threshold. In some examples, when the SMI workload is represented by a combination of (multiple) computing parameter values, the SMI management computing module 210 determines whether the computer parameter value of one or more of the computer parameter values is greater than a respective threshold. In some examples, when the SMI workload is represented by a combination of (multiple) computing parameter values, the SMI management computing module 210 determines whether the computer parameter value of each of the computer parameter values is greater than a respective threshold.

In some examples, the SMI management computing module 210 determines, based on the comparing, that the SMI workload is greater than the threshold value (at 310) and in response, determines whether the user 232 of the information handling system 202 is present with respect to the information handling system, at 312. Specifically, the presence detection computing module 220 can receive data from the camera 224 and/or the microphone 226. The data from the camera 224 can include images and/or video of a physical environment surrounding the information handling system 202, and the microphone can include audio of the physical environment surrounding the information handling system 202. The presence detection computing module 220 can analyze such data (images, video, audio) to determine the presence of the user 232 with respect to the information handling system 202. In some examples, the presence detection computing module 220 determines whether the user 232 is present with respect to the information handling system 202. In some examples, the presence detection computing module 220 determines whether the user 232 is present with respect to the information handling system 202 and attentive to the information handling system 202. In some examples, attentive to the information handling system 202 by the user 232 can include the user 232 facing the information handling system 202, “looking” at the information handling system 202, and/or providing input to the information handling system 202.

The presence detection computing module 220 provides data to the SMI management computing module 210 indicating the presence (or non-presence) of the user 232 with respect to the information handling system 202.

In some examples, the SMI management computing module 210 determines that the user 232 is present with respect to the information handling system 202 (at 312), and in response, throttles a frequency of the SMI requests between the OS computing module 212 and the firmware 214, at 314. That is, when the SMI workload is greater than the threshold and the user 232 is present with respect to the information handling system 202, the SMI management computing module 210 throttles the frequency of SMI requests between the OS computing module 212 and the firmware 214.

For example, the SMI management computing module 210 can provide a notification to the OS computing module 212 to throttle the SMI requests by an absolute value or a percentage. For example, the SMI management computing module 210 can provide the notification to the OS computing module 212 to throttle the SMI requests by a predetermined number of seconds, or by a predetermined percentage of seconds. For example, when a SMI request is provided every 5 seconds by the OS computing module 212, the SMI management computing module 210 can provide the notification to the OS computing module 212 to throttle the SMI requests by 3 seconds (to decrease the SMI request frequency from every 5 seconds to every 2 seconds) or throttle the SMI requests by 50% (to decrease the SMI request frequency from every 5 seconds to every 2.5 seconds).

In some examples, the SMI management computing module 210 determines that the user 232 is present with respect to the information handling system 202 (at 312), and in response, provides a notification indicating the reduced system performance and improvement of such (via throttled SMI requests). For example, the notification can be provided via the display 233.

In some examples, the SMI management computing module 210 determines that the user 232 is present with respect to the information handling system 202 (at 312), and in response, provides data to the client computing modules (through the OS computing module 212) indicating the throttling of the SMI requests. The SMI management computing module 210 can provide the data indicating the throttling of the SMI requests such that the client computing module 222 making the SMI request receives such, and/or other client computing modules 222 not actively making the SMI request receive such as well.

In some examples, the SMI management computing module 210 determines that the user 232 is not present with respect to the information handling system 202 (at 312), and in response, maintains the frequency of SMI requests between the OS computing module 212 and the firmware 214, at 316. That is, when the SMI workload is greater than the threshold and the user is not present with respect to the information handling system 202, the SMI management computing module 210 maintains the frequency of SMI requests between the OS computing module 212 and the firmware 214. That is, the SMI management computing module 210 does not throttle or adjust the frequency of SMI requests between the OS computing module 212 and the firmware 214.

In some examples, the SMI management computing module 210 determines, based on the comparing, that the SMI workload is greater than the threshold value (at 310) and in response, determines whether a workload of the information handling system 202 includes a media workload, at 318. For example, the workload can include an audio workload (audio stream) presented through the speakers 234, and/or a video workload (video stream) presented through the display 233 and/or the speakers 234. In other words, the SMI management computing module 210 can determine whether the information handling system 202 is currently presenting an audio stream or a video stream.

In some examples, step 318 can be performed concurrently (or substantially concurrently) with step 312. In some examples, step 318 can be performed before step 312 is performed. In some examples, step 318 can be performed after step 312 is performed.

In some examples, the SMI management computing module 210 determines that a workload of the information handling system 202 includes a media workload (at 318), and in response, throttles a frequency of the SMI requests between the OS computing module 212 and the firmware 214, at 320, similar to that of 314. The SMI management computing module 210 throttles a frequency of the SMI requests between the OS computing module 212 and the firmware 214 when the workload includes a media workload to reduce and/or minimize audio jittering, audio lag, and/or video lag of the media workload.

In some examples, the SMI management computing module 210 determines that a workload of the information handling system 202 does not include a media workload (at 318), and in response, maintains a frequency of the SMI requests between the OS computing module 212 and the firmware 214, at 322, similar to that of 316.

In some examples, the SMI management computing module 210 determines, based on the comparing, that the SMI workload is less than the threshold value (at 310) and in response, maintains a frequency of the SMI requests between the OS computing module 212 and the firmware 214, at 324, similar to that of 316.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing system management interrupt (SMI) requests at an information handling system, the method comprising:
identifying, while the information handling system is performing in an operating system (OS) mode, a plurality of SMI requests from the OS to firmware of the information handling system for telemetry data;
monitoring the SMI requests including receiving computing parameter values related to the SMI requests;
determining, based on the received computing parameter values, a SMI workload of the information handling system;
comparing the SMI workload to a threshold;
determining, based on the comparing, that the SMI workload is greater than the threshold, and in response:
determining whether a user of the information handling system is present with respect to the information handling system;
determining that the user of the information handling system is present with respect to the information handling system, and in response:
throttling a frequency of the SMI requests between the OS and the firmware.

2. The computer-implemented method of claim 1, wherein the computing parameter values include memory paging, processor workload, and SMI request frequency.

3. The computer-implemented method of claim 2, wherein determining the SMI workload includes determining the SMI workload based on the memory paging, the processor workload, and the SMI request frequency.

4. The computer-implemented method of claim 1, further including:
determining that the user of the information handling system is not present with respect to the information handling system, and in response:
maintaining the frequency of the SMI requests between the OS and the firmware.

5. The computer-implemented method of claim 1, further including:
determining, based on the comparing, that the SMI workload is greater than the threshold, and in response:
determining whether a workload of the information handling system includes a media workload;
determining that the workload of the information handling system includes the media workload, and in response:
throttling a frequency of the SMI requests between the OS and the firmware.

6. The computer-implemented method of claim 1, further including:
determining, based on the comparing, that the SMI workload is greater than the threshold, and in response:
determining whether a workload of the information handling system includes a media workload;
determining that the workload of the information handling system does not include the media workload, and in response:
maintaining the frequency of the SMI requests between the OS and the firmware.

7. The computer-implemented method of claim 1, further including:
determining, based on the comparing, that the SMI workload is less than the threshold, and in response:
maintaining the frequency of the SMI requests between the OS and the firmware.

8. An information handling system comprising a processor having access to memory media storing instructions executable by the processor to perform operations, comprising:
identifying, while the information handling system is performing in an operating system (OS) mode, a plurality of SMI requests from the OS to firmware of the information handling system for telemetry data;
monitoring the SMI requests including receiving computing parameter values related to the SMI requests;
determining, based on the received computing parameter values, a SMI workload of the information handling system;
comparing the SMI workload to a threshold;
determining, based on the comparing, that the SMI workload is greater than the threshold, and in response:
determining whether a user of the information handling system is present with respect to the information handling system;
determining that the user of the information handling system is present with respect to the information handling system, and in response:
throttling a frequency of the SMI requests between the OS and the firmware.

9. The information handling system of claim 8, wherein the computing parameter values include memory paging, processor workload, and SMI request frequency.

10. The information handling system of claim 9, wherein determining the SMI workload includes determining the SMI workload based on the memory paging, the processor workload, and the SMI request frequency.

11. The information handling system of claim 8, the operations further including:
determining that the user of the information handling system is not present with respect to the information handling system, and in response:
maintaining the frequency of the SMI requests between the OS and the firmware.

12. The information handling system of claim 8, the operations further including:
determining, based on the comparing, that the SMI workload is greater than the threshold, and in response:
determining whether a workload of the information handling system includes a media workload;
determining that the workload of the information handling system includes the media workload, and in response:
throttling a frequency of the SMI requests between the OS and the firmware.

13. The information handling system of claim 8, the operations further including:
determining, based on the comparing, that the SMI workload is greater than the threshold, and in response:
determining whether a workload of the information handling system includes a media workload;
determining that the workload of the information handling system does not include the media workload, and in response:
maintaining the frequency of the SMI requests between the OS and the firmware.

14. The information handling system of claim 8, the operations further including:
determining, based on the comparing, that the SMI workload is less than the threshold, and in response:
maintaining the frequency of the SMI requests between the OS and the firmware.

15. A non-transitory computer-readable medium storing software comprising instructions executable by one or more computers which, upon such execution, cause the one or more computers to perform operations comprising:
identifying, while the information handling system is performing in an operating system (OS) mode, a plurality of SMI requests from the OS to firmware of the information handling system for telemetry data;
monitoring the SMI requests including receiving computing parameter values related to the SMI requests;
determining, based on the received computing parameter values, a SMI workload of the information handling system;
comparing the SMI workload to a threshold;
determining, based on the comparing, that the SMI workload is greater than the threshold, and in response:
determining whether a user of the information handling system is present with respect to the information handling system;
determining that the user of the information handling system is present with respect to the information handling system, and in response:
throttling a frequency of the SMI requests between the OS and the firmware.

16. The non-transitory computer-readable medium of claim 15, wherein the computing parameter values include memory paging, processor workload, and SMI request frequency.

17. The non-transitory computer-readable medium of claim 16, wherein determining the SMI workload includes determining the SMI workload based on the memory paging, the processor workload, and the SMI request frequency.

18. The non-transitory computer-readable medium of claim 15, the operations further including:
determining that the user of the information handling system is not present with respect to the information handling system, and in response:
maintaining the frequency of the SMI requests between the OS and the firmware.

19. The non-transitory computer-readable medium of claim 15, the operations further including:
determining, based on the comparing, that the SMI workload is greater than the threshold, and in response:
determining whether a workload of the information handling system includes a media workload;
determining that the workload of the information handling system includes the media workload, and in response:
throttling a frequency of the SMI requests between the OS and the firmware.

20. The non-transitory computer-readable medium of claim 15, the operations further including:
determining, based on the comparing, that the SMI workload is greater than the threshold, and in response:
determining whether a workload of the information handling system includes a media workload;
determining that the workload of the information handling system does not include the media workload, and in response:
maintaining the frequency of the SMI requests between the OS and the firmware.
